(19) United States
(12) Patent Application Publication
(10) Pub. No.: US 2006/0027261 A1
(43) Pub. Date: Feb. 9, 2006

(54) Method for repair of regulator poppet and seat

(76) Inventors: Chuck W. Plevich, Casa Grande, AZ (US); Dennis L. Foulk, Glendale, AZ (US); Amer Aizaz, Phoenix, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/813,851

(22) Filed: Aug. 4, 2004

(51) Int. Cl. F16K 43/00

(52) U.S. Cl. 137/15.18

(57) ABSTRACT

There is provided a method for repair of a regulator valve. The present invention provides a method for repairing a regulator valve. The method provides a machining of a housing so as to incorporate an oversize poppet. A poppet is provided that matches the resized housing. Further the poppet is shaped so as to provide an increased efficiency in the regulation of the air flow through the valve. Additionally the poppet is selected of a material that provides an increased wear life over the original material.

### FIELD OF THE INVENTION

The present invention relates to regulator valves and the regulator poppet and seat of such a valve. More particularly, the present invention relates to methods and materials for repair of regulator poppets and seats as used in connection with regulator valves in gas turbine engines, such as for example, the selection and combination of materials that yields improved wear and performance characteristics for a regulator valve. Additionally, the present invention relates to a repair method for worn regulator valves that is easily adapted, yields improved performance, and also allows easy adjustment of the regulator valve.

### BACKGROUND OF THE INVENTION

Regulator valves are used in a variety of industrial applications. Broadly, regulator valves are used to provide on/off control of fluid flow as well as regulation of fluid flow. One common means whereby regulator valves provide this functionality is through a moveable poppet and seat where the movement of the poppet controls a flow area. This adjustable flow area further controls the degree of air flow through the valve. In this kind of design, the valve can restrict the flow of fluid through the valve when the poppet is in contact with the seat. Further, the volume rate of air flow through the valve is controlled by the degree to which the poppet is moved away from the seat, such that a greater linear movement yields a wider flow passage and thus greater volume movement of air.

Regulator valves find particular application in gas turbine engines. Gas turbine engines such as those used in industrial, marine, vehicle, and aerojet applications, typically include multiple stages of compressors. It has been found that bleed valves can be used at various points on a gas turbine engine to assist in maintaining a desired level of air pressure within given points of an engine. A bleed valve or series of bleed valves may be used to control undesired effects such as engine surge. Regulator valves may be used in conjunction with bleed valves to govern their operation.

Also in gas turbine engine systems, particularly as used in the aviation industry, bleed air is used to provide air flow for anti-icing equipment. In a common design air is drawn from the turbine engine and directed through a valve and duct network to desired points on the vehicle body. A regulator valve may be used in conjunction with the bleed valve to regulate the flow of bleed air gathered from the bleed valve and passed into the anti-icing system. In de-icing systems it is often desirable to be able to control the volume of air admitted into the system. Greater or lesser flow volumes may be required depending on environmental conditions. Thus the regulator valves that are the subject of this application find particular advantage in de-icing systems.

One regulator valve design is characterized by the use of a moveable poppet and seat. In such a design, a piston-like poppet slides back and forth within a cylinder-like housing. At one end of its movement the poppet rests against a seat. Movement of the poppet in the cylinder or housing results in wear on both the poppet and housing. As the contact between the poppet and the housing erodes these materials, the performance of the valve is degraded. In extreme cases, the piston may chatter within the housing; fluid control is lost and the valve may eventually fail. Further, as the poppet comes into repeated contact with the seat, the contact faces of the poppet and seat are also subject to wear. A regulator valve is therefore subject to wear, and the frequency and severity of the wear is increased in those regulator valves that have a high level usage or frequent cycle. This is often the case with those valves used in gas turbine engine systems.

The above-described wear that these valves encounter dictates that after a certain degree of wear a regulator valve must be repaired or replaced. For those valves in use in aviation control, and in particular critical functionality such as deicing control, the valves must meet performance criteria to remain in service. The option of replacing the valve with a new part is unattractive due to the expense involved. When a valve has experienced wear, it is often only the pieces that experience movement that have degraded while other parts of the valve are still usable.

Further, it may be economically disadvantageous to periodically inspect regulator valves for signs of wear and diminished performance. This testing is technically difficult and time consuming. In certain environments, such as with high capital equipment, it is also costly and undesirable to take a vehicle out of service for testing. Thus, regulator valves may be scheduled for repair and replacement on a time-usage basis rather than on a wear basis. In that kind of repair management there is a need for a regulator valve that has a demonstrably longer useful life so that replacement times may be extended.

It is therefore desirable to develop repair methods that are simple, inexpensive, and restore the regulator valve to a level of performance at least equal to, or preferably, superior to that of the original valve. With respect to those valves in the aviation industry it is further desired to develop repair methods that improve the life-cycle of the repaired valve so as to increase the service life of the valve. Also, it is desired that the repair method allow the valve to be quickly returned to service. Finally, it is also desired that repair methods allow for easy and quick adjustment of the regulator valve performance. The present invention addresses one or more of these needs.

### SUMMARY OF THE INVENTION

The present invention provides a method for repairing a regulator valve. The method provides a machining of a housing so as to incorporate an oversize poppet. A poppet is provided that matches the resized housing. Further the poppet is shaped so as to provide an increased efficiency in the regulation of the air flow through the valve. Additionally the poppet is selected of a material that provides an increased wear life over the original material.

In one embodiment, and by way of example only, there is provided a method for repairing a worn regulator valve comprising the steps of: boring a housing thereby creating a passage; and providing a poppet to fit slidably within the passage and wherein the poppet and housing fit so as to restrict airflow therebetween. The poppet may comprise NITRONIC 60 stainless steel. The method may further comprise boring a housing thereby creating a passage wherein the passage is substantially circular in cross-section and wherein the cross-section diameter is larger than the diameter of the worn regulator valve. Further the step of providing a poppet may further comprise a poppet defining a first surface and a second surface in contact with the passage. The poppet defines a tapered regulator with an angle of between about 6.5° and about 7.5° relative to the central axis of the poppet.

In a further embodiment, and by way of example only, there is provided a repaired regulator valve comprising: a housing having a passage wherein the housing comprises a nickel based alloy such as INCONEL 625 or 718; and a poppet disposed within the passage comprised of stainless steel or NITRONIC 60 stainless steel. The poppet further defines a tapered regulator at an angle of between approximately 6.5° and approximately 7.5° relative to the central axis of the poppet. The housing and poppet may regulate the flow of air into an aviation deicing system.

In a further embodiment, and still by way of example, there is provided a poppet for use in a regulator valve comprising: a stop; a first surface; a second surface; a tapered regulator defining an angle of between about 6.5° and about 7.5° relative to the central axis of the poppet; and a construction material comprising NITRONIC 60. The poppet may comprise a unitary piece. Additionally the first surface and the second surface may be substantially circular in cross section, and the diameter of the first surface and the diameter of the second surface are substantially equal.

Other independent features and advantages of the preferred regulator valve repair method will become apparent from the following detailed description, taken in conjunction with the accompanying drawings which illustrate, by way of example, the principles of the invention.

### BRIEF DESCRIPTION OF THE DRAWINGS

FIG. 1 is a perspective view of a regulator valve in accordance with one embodiment of the present invention.

FIG. 2 is a detailed perspective view of a poppet in accordance with one embodiment of the present invention.

FIG. 3 is a perspective view of a poppet showing signs of wear.

FIG. 4 is a graph showing improved performance associated with a regulator valve used in accordance with one embodiment of the present invention.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. Reference will now be made in detail to exemplary embodiments of the invention, examples of which are illustrated in the accompanying drawings. Wherever possible the same reference numbers will be used throughout the drawings to refer to the same or like parts.

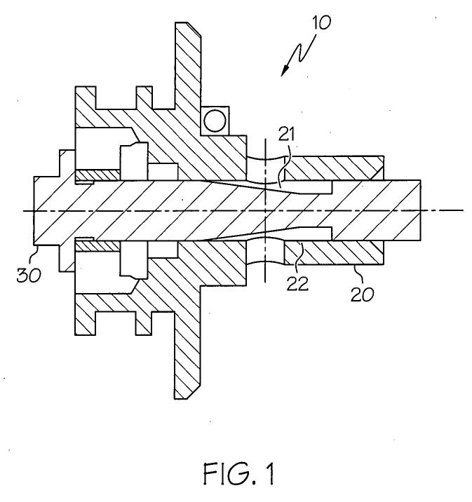

Referring to FIG. 1 there is shown a perspective view of a regulator valve in accordance with one embodiment of the present invention. Valve 10 comprises a housing 20 and poppet 30. Housing 20 defines a hollow passage 21 that is preferably cylindrical in cross sectional shape. Housing 20 may include ducts that provide fluid communication through housing 20 and with passage 21. Passage 21 of housing 20 defines a guide surface 22. Poppet 30 is disposed within passage 21 and may move therein in an axial direction.

Housing 20 is preferably made of an airplane grade alloy. Preferably housing 20 comprises an aircraft grade nickel alloy such as INCONEL 625 or INCONEL 718. Other INCONEL alloys may also be used for housing. Housing 20 may comprise a unitary piece, or more commonly is an assembled piece of multiple parts. Preferably housing 20 comprises INCONEL alloy 625 or 718 along the portion of material that forms hollow passage 21 and surface 22.

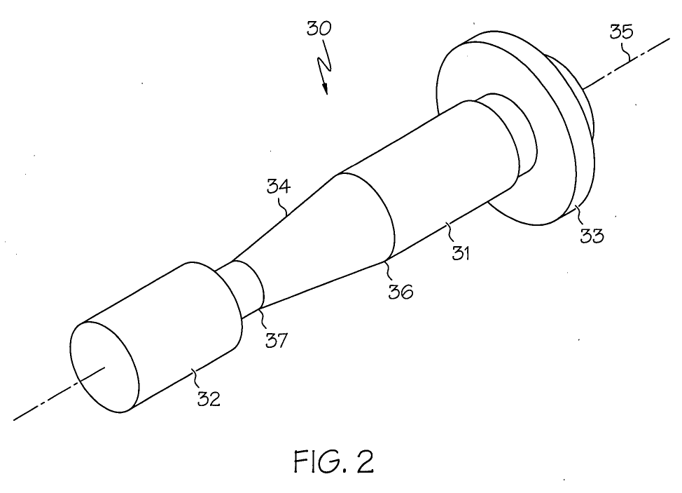

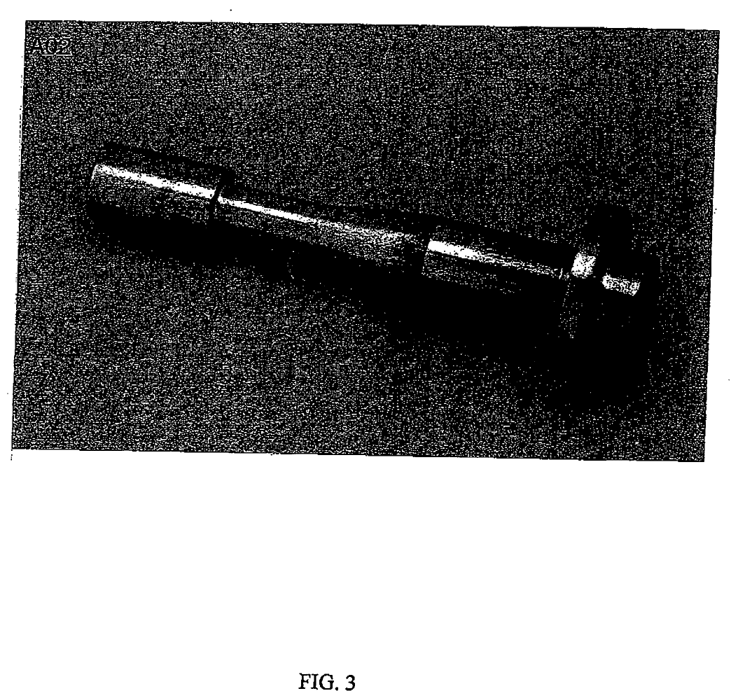

Referring now to FIG. 2 there is shown a detailed view of poppet 30. Poppet 30 includes a first surface 31 and second surface 32. First and second surfaces 31, 32 are preferably circular in cross section and correspond to the cross sectional diameter of passage 21. First and second surfaces 31 and 32 are thus contact points that slide along guide surface 22 of housing 20. As shown in FIG. 3, which illustrates a worn poppet, first surface 31 and second surface 32 are subject to degradation. The shaded area in FIG. 3 illustrates areas on first surface 31 and second surface 32 that have experienced wear. Referring again to FIG. 2 the fit between passage 21 and first and second surfaces 31, 32 is such that air is substantially restricted from flowing therethrough. It is recognized that minute pressure drops or air flow may occur at these contact points, nevertheless it will be appreciated by those skilled in the art that the contact is substantial enough so that the valve functions for its intended purpose.

Referring still to FIG. 2, poppet 30 further includes stop 33. Stop 33 defines a limit of travel of poppet 30 within housing 20. As shown in a preferred embodiment, stop 33 is a cylindrical extension with diameter greater than that of passage 21. Thus stop 33 cannot enter into passage 21. At a limit of travel, stop 33 contacts housing 20 thereby preventing further movement of poppet 30.

Not shown in FIG. 2 is additional structure attached to poppet 30. An adjusting screw and spring may be attached to poppet 30. In this arrangement tightening a screw depresses a spring so as to increase a resistive force that acts on poppet 30. Correspondingly, loosening the screw tends to expand the spring and thus decreases the force that acts on the poppet.

Also shown in FIG. 2 as part of poppet 30 is tapered restrictor 34. In a preferred embodiment tapered restrictor 34 is an angled element that defines a circumferential area of poppet 30. Thus when poppet 30 is disposed within passage 21, there is a volume defined in the region surrounding tapered restrictor 34 and within passage 21. As illustrated, the diameter along the length of tapered restrictor 34 is less than the diameter of passage 21. In a preferred embodiment, tapered restrictor 34 is set at a preferred angle relative to the central axis 35 of poppet 30. In a preferred embodiment, that angle is about 7°. The line defined by tapered restrictor 34 generally begins at initiation point 36 on first surface 31 and continues to a termination point 37. The linear distance between initiation point 36 and termination point 37, as measured along axis 35 can vary. Preferably tapered restrictor 34 is machined from a unitary piece with poppet 30.

A method of repairing a regulator valve is as follows. A valve is removed from service and disassembled. Components such as housing 20 may be cleaned and degreased. Passage 21 is bored so as to increase its internal diameter to a desired level. Known machining methods such as drilling, boring, and reaming can be used to perform this step. Passage 21 is finished and polished.

Poppet 30 is prepared for installation into passage 21. Poppet 30 is fashioned by known techniques such as forging, casting, and machining. Preferably poppet 30 is formed of a unitary material selected for increased wear life within housing 20. One preferred material that demonstrates increased wear life with typical housing materials is a stainless steel bar/rod with specification UNS S21800 and sold under the tradename NITRONIC 60. Preferably this material conforms to ASTM A 276 and satisfies condition A thereof for annealing. When the housing is a nickel superalloy such as INCONEL 625, which is typical in aircraft valve applications, poppet 30 demonstrates a significantly increased wear life when made of NITRONIC 60.

Stainless steel that is sold under the tradename NITRONIC 60 has the following general specification by weight percentage. The weight percentages shown are approximate.

| Element | Wt % |
|---|---|
| Carbon | 0.1 max |
| Chromium | 16-18 |
| Iron | Balance |
| Manganese | 7-9 |
| Nickel | 8-9 |
| Nitrogen | 0.08-0.18 |
| Phosphorus | 0.04 max |
| Silicon | 3.5-4.5 |
| Sulphur | 0.03 max |

Any stainless steel with this composition can be used as material of construction for the poppet.

Poppet 30 is formed so that first surface 31 and second surface 32 fit within passage 21 as described above. That is the diameter of first and second surfaces 31, 32 corresponds to the internal diameter of passage 21 so as to restrict air flow therebetween.

Poppet 30 is further formed so that tapered restrictor 34 preferably defines approximately a 7° angle with respect to the central axis of poppet 30. Preferably tapered restrictor 34 is within about 0.5° of the 7° angle.

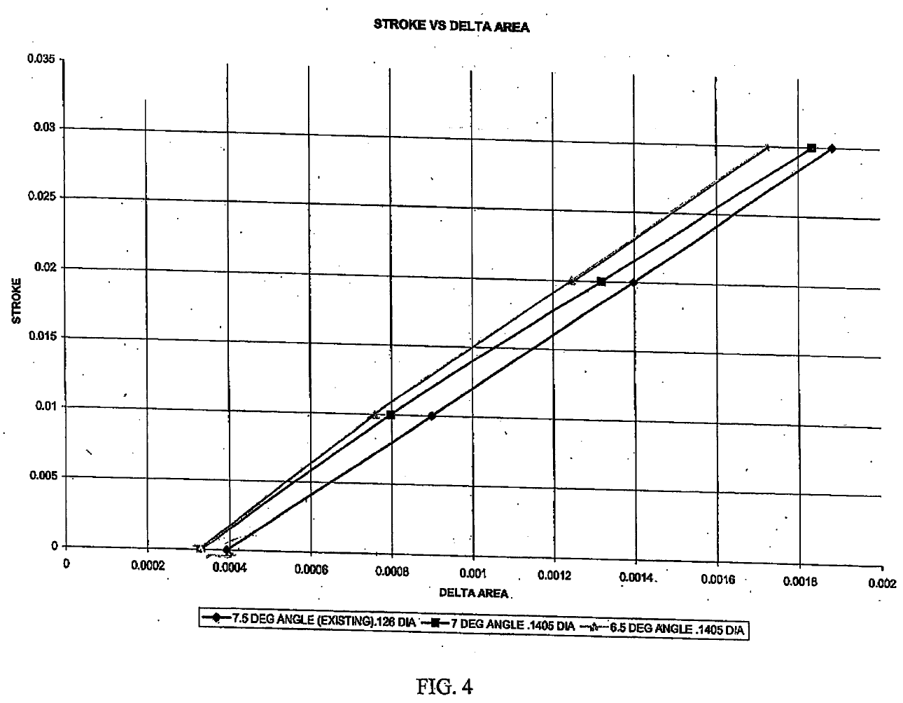

FIG. 4 illustrates the advantage of using the tapered shape for the poppet. The graph illustrates the stroke versus delta area for various tapers. The slope of the plot also corresponds to the ease by which a given configuration can be adjusted. The lower slope of the 7° angle illustrates an improvement in adjustability.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A method for repairing a worn regulator valve comprising the steps of:
boring a housing thereby creating a passage; and
providing a poppet to fit slidably within the passage and wherein the poppet and housing fit so as to restrict airflow therebetween.

2. The method according to claim 1 wherein the step of boring a housing further comprises boring a housing thereby creating a passage wherein said passage is substantially circular in cross-section and wherein the cross-section diameter is larger than the diameter of the worn regulator valve.

3. The method according to claim 1 wherein the step of providing a poppet further comprises a poppet defining a first surface and a second surface in contact with the passage.

4. The method according to claim 1 wherein the step of providing a poppet further comprises a poppet comprising NITRONIC 60 stainless steel.

5. The method according to claim 1 wherein the step of providing a poppet further comprises a poppet defining a tapered regulator with an angle of between about 6.5° and about 7.5° relative to the central axis of the poppet.

6. A repaired regulator valve comprising:
a housing having a passage wherein said housing comprises a nickel based alloy;
a poppet disposed within said passage.

7. The repaired regulator valve according to claim 6 wherein said poppet comprises the metal alloy NITRONIC 60.

8. The repaired regulator valve according to claim 6 wherein said housing comprises INCONEL 625.

9. The repaired regulator valve according to claim 6 wherein said housing comprises INCONEL 718.

10. The repaired regulator valve according to claim 6 wherein said poppet further defines a tapered regulator at an angle of approximately 7° relative to the central axis of the poppet.

11. The repaired regulator valve according to claim 6 wherein said poppet further defines a tapered regulator at an angle of between approximately 6.5° and approximately 7.5° relative to the central axis of the poppet.

12. The repaired regulator valve according to claim 6 wherein said housing and poppet regulate the flow of air into an aviation deicing system.

13. A regulator valve comprising:
a housing defining a substantially circular passage and wherein said housing comprises a nickel-based superalloy;
a poppet slidably disposed within the circular passage of the housing, wherein said poppet comprises stainless steel; and
said poppet further defining a first surface and a second surface in contact with said housing; and said poppet further defining a tapered regulator positioned between said first surface and said second surface; and
a stop affixed to the poppet wherein said stop limits the movement of the poppet when said stop is in contact with the housing.

14. The regulator valve according to claim 13 wherein said poppet comprises NITRONIC 60 stainless steel.

15. The regulator valve according to claim 13 wherein said housing comprises INCONEL 625.

16. The regulator valve according to claim 13 wherein said tapered surface defines an angle of between about 6.5° and about 7.5° relative to the central axis of the poppet.

17. The regulator valve according to claim 13 wherein said tapered surface defines an angle of approximately 7.0° relative to the central axis of the poppet.

18. A poppet for use in a regulator valve comprising:
a stop;
a first surface;
a second surface;
a tapered regulator defining an angle of between about 6.5° and about 7.5° relative to the central axis of the poppet; and
a construction material comprising NITRONIC 60.

19. The poppet according to claim 18 wherein said poppet comprises a unitary piece.

20. The poppet according to claim 18 wherein said first surface and said second surface are substantially circular in cross section and wherein the diameter of said first surface and the diameter of said second surface are substantially equal.
